(19) United States
(12) Patent Application Publication
(10) Pub. No.: US 2023/0276730 A1
(43) Pub. Date: Sep. 7, 2023

(54) HARVESTING SYSTEM BASED ON A PLATFORM FOR AGRICULTURAL HARVESTERS, AND PLATFORM FOR AGRICULTURAL HARVESTERS

(71) Applicant: CNH Industrial Brasil Ltda., Nova Lima (BR)

(72) Inventors: Mauro de Azevedo BARRETTO, Cotia (BR); Alysson Renato BENTO, Piracicaba (BR); Marcio Rodrigues DA SILVA, Itatiba (BR)

(21) Appl. No.: 18/017,601

(22) PCT Filed: Jul. 22, 2021
(86) PCT No.: PCT/BR2021/050311

§ 371 Date: Jan. 23, 2023

(30) Foreign Application Priority Data
Jul. 24, 2020 (BR) 102020015140-1

(51) Int. Cl. A01D 33/14; A01D 34/24; A01D 45/10; A01D 57/22

(52) U.S. Cl. CPC A01D 33/14; A01D 34/246; A01D 45/10; A01D 57/22

(57) ABSTRACT

In one aspect, the present subject matter is directed to a header-based harvesting system for agricultural harvesters that includes a header configured to be removably coupled to a front end of a harvester. The header includes a header frame and a base cutter assembly coupled to the header frame in a floating arrangement. Additionally, the system includes an actuator coupled between the header frame and the base cutter assembly, and a hydraulic circuit in fluid communication with the actuator. The hydraulic circuit is configured to allow pressurized hydraulic fluid to be supplied to the actuator for regulating the floating movement of the base cutter assembly relative to the header frame.

### FIELD OF THE INVENTION

The present subject matter relates generally to headers for agricultural harvesters, such as sugarcane harvesters, and, more particularly, to a floating base cutter assembly for a header of an agricultural harvester and related systems and hydraulic circuits for accommodating the floating base cutter assembly.

### BACKGROUND OF THE INVENTION

In an ever-changing agricultural landscape, adaptability is important to allow both manufacturers of agricultural harvesters and the end-users of such harvesters to be able to accommodate varying market demands, as well as varying trends in planting arrangements and/or the like. The need for such adaptability is particularly relevant in the cultivation and harvesting of sugarcane and other tall, stalky patents, where the industry is undergoing a rapid evolution in terms of both the development of new varieties of plants and the use of varying planting configurations, all with an eye towards increased productivity. In this regard, manufacturers of sugarcane harvesters have made substantial efforts to provide machines that accommodate the varying market demands, such as by designing harvesters capable of harvesting two or more crop rows as opposed to a single row (i.e., multi-row harvesting). However, to date, conventional harvesters have been specifically adapted for the specific type of harvesting operations being performed, such as by having a specific frame or chassis configuration for single row harvesting, a different frame or chassis configuration for multi-row harvesting, and yet another frame or chassis configuration for header-based harvesting. Accordingly, to provide commercial versions of each of such machines, current manufacturers are required to spend substantial time and capital in the development and deployment of such machine variations.

To address such issues, it has been recently proposed to provide detachable headers for sugarcane harvesters to allow a single machine to be adapted for providing multiple harvesting configurations. For instance, US Patent Publication Number 2017/0000026, filed Jun. 30, 2016 and assigned to CNH Industrial America LLC, discloses a header that can be used with sugarcane harvesters, the disclosure of which is hereby incorporated by reference herein in its entirety for all purposes. Such a removable or detachable header provides numerous advantages over prior known machines. However, further refinements and improvements to headers configured for use with sugarcane harvesters are still desired to accommodate the ever-changing market demands. For instance, the base cutter assemblies used within conventional non-header-based harvesters are typically fixed to the main chassis or frame of the harvester, thereby requiring the entire machine to be raised and lowered to adjust the vertical positioning of the base cutter assemblies in view of changing ground contours or profiles. However, a new cutter configuration is generally desirable for use with header-based harvesters to allow the position of a base cutter assembly to be adjusted in a more efficient and effective manner.

Accordingly, what is needed in the industry is a new base cutter assembly and related systems/componentry that can be used with detachable harvester headers, such as headers configured for use with sugarcane harvesters.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a header-based harvesting system for agricultural harvesters. The system includes a header configured to be removably coupled to a front end of a harvester. The header includes a header frame and a base cutter assembly coupled to the header frame in a floating arrangement. Additionally, the system includes an actuator coupled between the header frame and the base cutter assembly, and a hydraulic circuit in fluid communication with the actuator. The hydraulic circuit is configured to allow pressurized hydraulic fluid to be supplied to the actuator for regulating the floating movement of the base cutter assembly relative to the header frame.

In another aspect, the present subject matter is directed to a header for agricultural harvesters. The header includes a header frame configured to be removably coupled to a front end of an agricultural harvester, and a base cutter assembly coupled to the header frame. The base cutter assembly includes at least one cutting blade and a drive assembly configured to rotationally drive the at least one cutting blade. The header also includes a linkage assembly coupling the base cutter assembly to the header frame such that the base cutter assembly is movable relative to the header frame in both a first direction and a second direction opposite the first direction. Additionally, the header includes an actuator coupled between the header frame and the base cutter assembly, with the actuator being configured to allow the base cutter assembly to float relative to the header frame in both the first direction and the second direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of a prior art agricultural harvester in accordance with aspects of the present subject matter;

FIG. 2 illustrates a simplified, side view of one embodiment of an agricultural harvester including a detachable header in accordance with aspects of the present subject matter;

FIG. 3 illustrates a simplified, front view of one embodiment of a header configured for use with an agricultural harvester in accordance with aspects of the present subject matter, particularly illustrating the header including one embodiment of a floating base cutter assembly in accordance with aspects of the present subject matter;

FIG. 4 illustrates a simplified, side view of the header shown in FIG. 3, particularly illustrating the base cutter assembly coupled to a frame of the header via a pantographic arrangement; and

FIG. 5 illustrates a schematic view of one embodiment of a hydraulic circuit for regulating the movement of a floating base cutter assembly in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a floating base cutter assembly for a header configured for use with an agricultural harvester, such as a sugarcane harvester. Additionally, in several embodiments, the present subject matter is directed to a header-based harvesting system for an agricultural harvester that includes, for example, a header and a base cutter assembly configured to float relative to a frame of the header.

In several embodiments, the base cutter assembly may be configured to be coupled to the header frame using a pantographic arrangement that allows the base cutter assembly to float or move relative to the header frame in generally opposed directions, such as a substantially upward direction and substantially downward direction. For example, in one embodiment, the base cutter assembly may be coupled to the header frame via a linkage assembly including first and second linkages or pivot arms forming a four-bar linkage between the base cutter assembly and the header frame. Such bi-directional movement of the base cutter assembly relative to the header frame may generally permit the base cutter assembly to follow variations in the ground contour during the performance of a harvesting operation, such as by allowing the base cutter assembly to move both upwardly relative to the frame when the assembly encounters a raised surface profile and downwardly relative to the frame when the assembly encounters a recessed surface profile.

Additionally, to regulate the floating movement of the base cutter assembly relative to the header frame, a hydraulic actuator may be coupled between the base cutter assembly and the header frame that is fluid communication with a hydraulic circuit. In several embodiments, the hydraulic circuit may generally be configured to supply pressurized hydraulic fluid to the actuator in a manner that permits the actuator to apply a substantially constant load against the associated base cutter assembly, thereby allowing the base cutter assembly to be maintained in contact the ground with a desired downforce or pressure. For example, in one embodiment, the hydraulic circuit may be configured to utilize the concept of a regenerative cylinder to maintain a constant load applied through the base cutter assembly in both movement directions relative to the header frame (e.g., both upward and downward movement), such as by including a pressure accumulator within the hydraulic circuit that is configured to prevent or minimize temporary pressure fluctuations within the circuit.

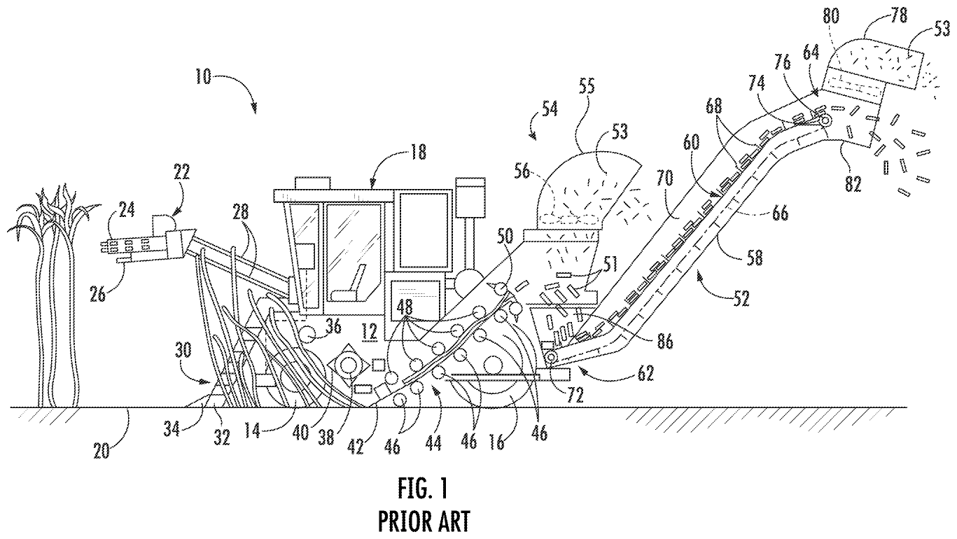

Referring now to the drawings, FIG. 1 illustrates a side view of one embodiment of a typical sugarcane harvester 10 known in the art. As shown in FIG. 1, the harvester 10 includes a frame 12, a pair of front wheels 14, a pair of rear wheels 16, and an operator's cab 18. The harvester 10 also includes a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

Additionally, the harvester 10 includes various components for cutting/harvesting, processing, cleaning, and discharging sugarcane as the cane is harvested from an agricultural field 20. For instance, the harvester 10 includes a topper assembly 22 positioned at its front end to intercept sugarcane as the harvester 10 is moved in the forward direction. As shown, the topper assembly 22 includes both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 is adjustable via a pair of arms 28 hydraulically raised and lowered, as desired, by the operator.

Additionally, the harvester 10 includes a crop divider 30 that extends upwardly and rearwardly from the field 20. In general, the crop divider 30 may include two spiral feed rollers 32. Each feed roller 32 includes a ground shoe 34 at its lower end to assist the crop divider 30 in gathering the sugarcane stalks for harvesting. Moreover, as shown in FIG. 1, the harvester 10 includes a knock-down roller 36 positioned near the front wheels 14 and a fin roller 38 positioned behind the knock-down roller 36. As the knock-down roller 36 is rotated, the sugarcane stalks being harvested are knocked down while the crop divider 30 gathers the stalks from agricultural field 20. Further, as shown in FIG. 1, the fin roller 38 includes a plurality of intermittently mounted fins 40 that assist in forcing the sugarcane stalks downwardly. As the fin roller 38 is rotated during the harvest, the sugarcane stalks that have been knocked down by the knock-down roller 36 are separated and further knocked down by the fin roller 38 as the harvester 10 continues to be moved in the forward direction relative to the field 20.

Referring still to FIG. 1, the harvester 10 also includes a base cutter assembly 42 mounted on the frame 12 behind the fin roller 38. As is generally understood, the base cutter assembly 42 includes blades (not shown) for severing the sugarcane stalks as the cane is being harvested. The blades, located on the periphery of the assembly 42, may be rotated by a hydraulic motor (not shown) powered by the vehicle's hydraulic system. As indicated above, the base cutter assembly 42 is generally provided in a fixed positional relationship with the frame 12, thereby requiring the entire machine to be raised and lowered to adjust the vertical positioning of the assembly 42 when encountering variations in the ground contour.

Moreover, the harvester 10 includes a feed roller assembly 44 located downstream of the base cutter assembly 42 for moving the severed stalks of sugarcane from base cutter assembly 42 along the processing path. As shown in FIG. 1, the feed roller assembly 44 includes a plurality of bottom rollers 46 and a plurality of opposed, top pinch rollers 48. The various bottom and top rollers 46, 48 are generally used to pinch the harvested sugarcane during transport. As the sugarcane is transported through the feed roller assembly 44, debris (e.g., rocks, dirt, and/or the like) is allowed to fall through bottom rollers 46 onto the field 20.

In addition, the harvester 10 includes a chopper assembly 50 located at the downstream end of the feed roller assembly 44 (e.g., adjacent to the rearward-most bottom and top feed rollers 46, 48). In general, the chopper assembly 50 is used to cut or chop the severed sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugarcane billets 51 are expelled from the harvester 10 through a primary extractor 54, which is located immediately behind the chopper assembly 50 and is oriented to direct the debris 53 outwardly from the harvester 10. The primary extractor 54 may include, for example, an extractor hood 55 and an extractor fan 56 mounted within the hood 55 for generating a suction force or vacuum sufficient to pick up the debris 53 and force the debris 53 through the hood 55. The separated or cleaned billets 51, heavier than the debris 53 being expelled through the extractor 54, may then fall downward to the elevator assembly 52.

As shown in FIG. 1, the elevator assembly 52 generally includes an elevator housing 58 and an elevator 60 extending within the elevator housing 58 between a lower, proximal end 62 and an upper, distal end 64. In general, the elevator 60 includes a looped chain 66 and a plurality of flights or paddles 68 attached to and evenly spaced on the chain 66. The paddles 68 are configured to hold the sugarcane billets 51 on the elevator 60 as the billets are elevated along a top span 70 of the elevator 70 defines between its proximal and distal ends 62, 64. Additionally, the elevator 60 includes lower and upper sprockets 72, 74 positioned at its proximal and distal ends 62, 64, respectively. As shown in FIG. 1, an elevator motor 76 is coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Moreover, in some embodiments, pieces of debris 53 (e.g., dust, dirt, leaves, etc.) separated from the elevated sugarcane billets 51 may be expelled from the harvester 10 through a secondary extractor 78 coupled to the rear end of the elevator housing 58. For example, the debris 53 expelled by the secondary extractor 78 may be debris remaining after the billets 51 are cleaned and debris 53 expelled by the primary extractor 54. As shown in FIG. 1, the secondary extractor 78 is located adjacent to the distal end 64 of the elevator 60 and may be oriented to direct the debris 53 outwardly from the harvester 10. Additionally, an extractor fan 80 is mounted at the base of the secondary extractor 78 for generating a suction force or vacuum sufficient to pick up the debris 53 and force the debris 53 through the secondary extractor 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

During operation, the harvester 10 is traversed across the agricultural field 20 for harvesting sugarcane. After the height of the topper assembly 22 is adjusted via the arms 28, the gathering disk 24 on the topper assembly 22 functions to gather the sugarcane stalks as the harvester 10 proceeds across the field 20, while the cutter disk 26 severs the leafy tops of the sugarcane stalks for disposal along either side of harvester 10. As the stalks enter the crop divider 30, the ground shoes 34 set the operating width to determine the quantity of sugarcane entering the throat of the harvester 10. The spiral feed rollers 32 then gather the stalks into the throat to allow the knock-down roller 36 to bend the stalks downwardly in conjunction with the action of the fin roller 38. Once the stalks are angled downwardly as shown in FIG. 1, the base cutter assembly 42 severs the base of the stalks from field 20. The severed stalks are then, by movement of the harvester 10, directed to the feed roller assembly 44.

The severed sugarcane stalks are conveyed rearwardly by the bottom and top feed rollers 46, 48, which compress the stalks, make them more uniform, and shake loose debris to pass through the bottom rollers 46 to the field 20. At the downstream end of the feed roller assembly 44, the chopper assembly 50 cuts or chops the compressed sugarcane stalks into pieces or billets 51 (e.g., 6 inch cane sections). The processed crop material discharged from the chopper assembly 50 is then directed as a stream of billets 51 and debris 53 into the primary extractor 54. The airborne debris 53 (e.g., dust, dirt, leaves, etc.) separated from the sugarcane billets is then extracted through the primary extractor 54 using suction created by the extractor fan 56. The separated/cleaned billets 51 then fall downwardly through an elevator hopper 86 into the elevator assembly 52 and travel upwardly via the elevator 60 from its proximal end 62 to its distal end 64. During normal operation, once the billets 51 reach the distal end 64 of the elevator 60, the billets 51 fall through the elevator discharge opening 82 to an external storage device. If provided, the secondary extractor 78 (with the aid of the extractor fan 80) blows out trash/debris 53 from harvester 10, similar to the primary extractor 54.

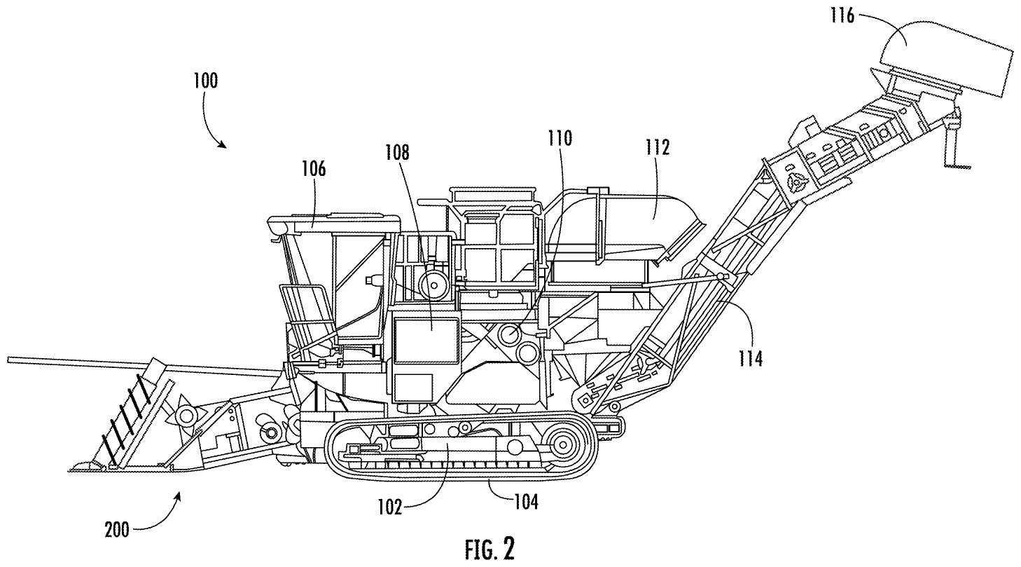

Referring now to FIG. 2, a side view of one embodiment of a sugarcane harvester 100 incorporating a detachable or removable header 200 is illustrated in accordance with aspects of the present subject matter. In general, the operation of the harvester 100 shown in FIG. 2 is the same as or similar to the operation of the harvester 10 described above with reference to FIG. 1 and, thus, the specific details of such harvester operation need not be described below. For instance, the harvester 100 may generally include the same or similar components used for cutting/harvesting, processing, cleaning, and discharging sugarcane as the harvester 10 described above.

As shown in FIG. 2, the harvester 100 includes a frame 102 mounted on ground-engaging tracks 104 and an operator's cab 106 supported on the frame 102. In other embodiments, as opposed to being track-driven, the harvester 100 may, instead, include pairs of front and rear wheels (e.g., similar to that described above with reference to FIG. 1). The harvester 100 also includes a primary source of power (e.g., an engine 108 mounted on the frame 102) which powers the tracks 104 via a transmission (not shown). The engine 108 may also drive a hydraulic fluid pump (not shown) configured to generate pressurized hydraulic fluid within a main hydraulic circuit for powering various hydraulic components of the harvester 100.

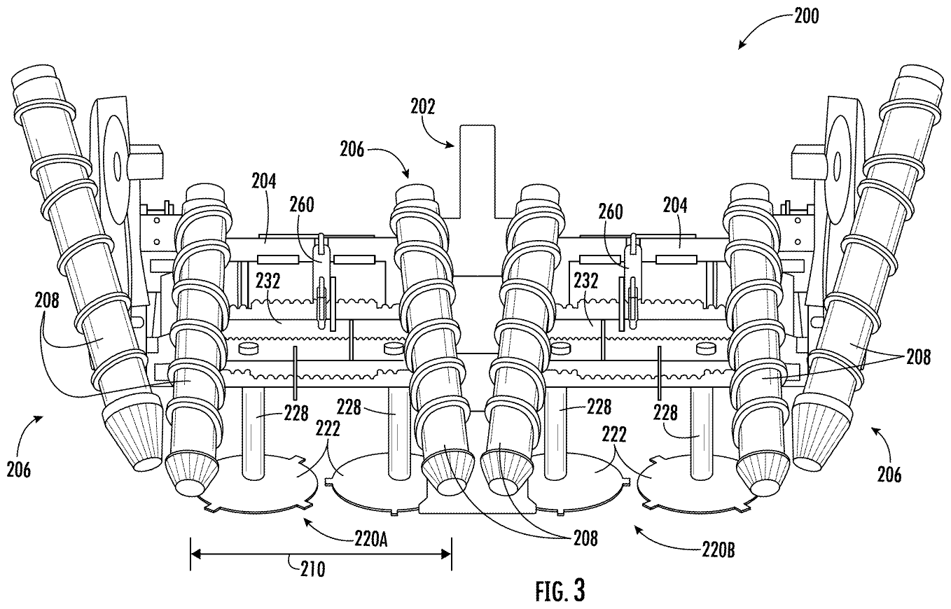

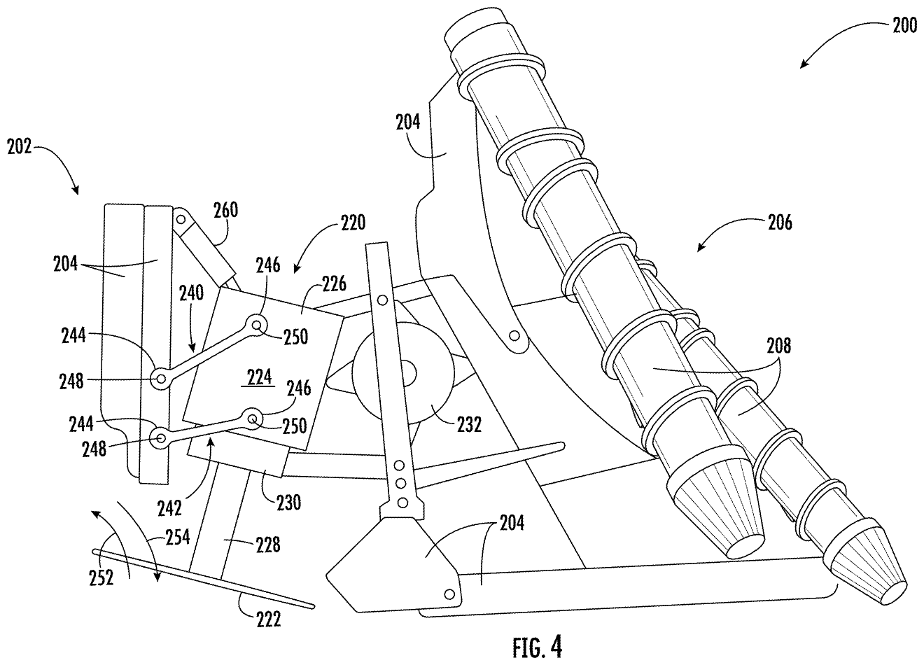

Additionally, the harvester 100 includes various components for cutting/harvesting, processing, cleaning, and discharging sugarcane as the cane is harvested from an agricultural field. However, unlike the embodiment of the harvester 10 described above, a portion of such components are installed on/within and/or are otherwise provided in operative association with a detachable header 200 configured to be removably coupled to the front end of the chassis or frame 102 of the harvester 100. For instance, as will be described below with reference to FIGS. 3 and 4, various upstream components associated with the harvesting process, such as a topper assembly, crop dividers, knock down rollers, fin rollers, base cutter assemblies, and/or the like, may be supported on or otherwise provided in operative association with the header 200. In such an embodiment, the remainder of the harvesting-related components positioned downstream of the header 200 may be installed on the main frame 102 of the harvester 100, such as a feed roller assembly, a chopper assembly, a primary extractor, an elevator assembly, a secondary extractor, and/or the like. For example, in the illustrated embodiment of FIG. 2, the severed sugarcane stalks provided via the harvesting components supported on the header 200 may be delivered via a feed roller assembly (not shown) supported on the harvester frame 102 to an associated chopper assembly 110, which cuts the stalks into pieces or billets and directs the billets (and corresponding debris) towards a primary extractor 112 for cleaning. The cleaned billets are then transported upwardly via an elevator assembly 114 for delivery to an external storage device, with an optional secondary extractor 116 being provided at the distal end of the elevator assembly 114 to provide an additional means for removing trash/debris from the flow of billets being expelled from the harvester 100.

It should be appreciated that the header 200 may generally be configured to be coupled to the frame 102 of the harvester 100 using any suitable attachment or connection means, including any fastening means typically utilized for coupling header attachments to harvesters. For instance, in one embodiment, suitable hooks, locks, flanges, bolts, and/or the like may be used to couple the header 200 to the front end of the harvester 100.

Referring now to FIGS. 3 and 4, different schematic views of one embodiment of a detachable or removable header 200 suitable for use with an agricultural harvester, such as the harvester 100 described above with reference to FIG. 2, are illustrated in accordance with aspects of the present subject matter. Specifically, FIG. 3 illustrates a simplified, front view of the header 200 and FIG. 4 illustrates a simplified, side view of the header 200, with various frame or structural components being removed from the header 200 in both the front and side views to simplify the drawings and to allow certain header components to be clearly shown therein.

As shown in the illustrated embodiment, the header 200 includes a main chassis or frame 202. In general, the frame 202 may form the support structure for the header 200 and, thus, may include a plurality of structural elements and/or frame members 204 (many of which are not shown for purposes of illustration) configured to be coupled together in a manner that allows the frame 202 to support the various header-related components described herein. Additionally, the frame 202 is configured to be removably or detachably coupled to the front end of a harvester. For instance, as indicated above, the header frame 202 may be configured to be coupled to the frame of an associated harvester using any suitable attachment or connection means, such as hooks, locks, flanges, bolts, and/or the like.

It should be appreciated that, depending on the desired harvesting configuration for the header 200, the frame 202 may generally have any suitable configuration, including being configured to support any number of related harvesting components. For instance, in the illustrated embodiment, the frame 202 is generally configured to provide a multi-row harvesting configuration for harvesting two or more rows of sugarcane simultaneously. However, in other embodiments, the frame 202 may be configured to provide any other suitable harvesting configuration for the header 200, such as a single-row harvesting configuration, and/or the like.

As shown in the illustrated embodiment, the header 200 includes three crop dividers 206 spaced apart laterally across the width of the frame 202. In general, each crop divider 206 may include one or more spiral feed rollers 208 (e.g., a pair of spiral feed rollers 208) configured to separate the crop row(s) to be harvested from adjacent rows and gather such crop row(s) for subsequent processing. In this regard, the lateral spacing 210 between adjacent crop dividers 206 may generally be selected based on the desired number of crop rows to be harvested. For instance, in one embodiment, the lateral spacing 210 may be selected such that a single crop row is fed between adjacent crop dividers 206 for harvesting, thereby allowing the header 200 to harvest two crop rows simultaneously. In another embodiment, the lateral spacing 210 may be increased to allow two or more crop rows to be fed between adjacent crop dividers 206 for harvesting, thereby allowing the header 200 to harvest four or more crop rows simultaneously. It should also be appreciated that, in alternative embodiments, the header 200 may only include two crop dividers 206 spaced apart across the width of the frame 202, with the lateral spacing 210 between such crop dividers 206 being selected to provide, for example, a single-row harvesting configuration or a multi-row harvesting configuration for the header 200. In yet another embodiment, the header 200 may include four or more crop dividers 206 spaced apart laterally across the width of the frame 202.

Additionally, as shown in the illustrated embodiment, the header 200 includes two base cutter assemblies 220 supported by the frame 202 at locations rearward or aft of the crop dividers 206. For instance, as particularly shown in FIG. 3, a first base cutter assembly 220A is generally aligned behind the pair of crop dividers 206 formed by the leftmost divider 206 and the central divider 206 to allow the stalks of the crops gathered between such dividers 206 to be severed. Additionally, a second base cutter assembly 220A is generally aligned behind the pair of crop dividers 206 formed by the rightmost divider 206 and the central divider 206 to allow the stalks of the crops gathered between such dividers 206 to be severed.

In several embodiments, each base cutter assembly 220 may include at least one rotatable cutting blade 222 (e.g., a pair of cutting blades 222) configured to sever the stalks of the crop being fed between the crop dividers 206 positioned forward of the base cutter assembly 220. As particularly shown in FIG. 4, the cutting blades 222 may, for example, be angled downwardly to ensure that the base of the stalk is severed as close as possible to the ground. Moreover, each base cutter assembly 200 may include a drive assembly 224 for rotationally driving the associated pair of cutting discs 222. In one embodiment, each drive assembly 224 may include a single drive source for rotationally driving the cutting blades 222. For instance, each drive assembly 224 may include a single drive motor 226 (e.g., a hydraulic motor) coupled to corresponding drive shafts 228 via respective gearboxes 230, thereby allowing the drive motor 226 to rotationally drive both cutting blades 222. In alternative embodiments, each cutting blade 222 may be configured to be rotationally driven by a separate drive source, such as a separate drive motor 226 provided for each respective cutting blade 222.

In accordance with aspects of the present subject matter, each base cutter assembly 220 may be configured to be coupled to the header frame 202 in a floating arrangement that allows the base cutter assembly 220 to float or move relative to the frame 202. Specifically, in several embodiments, each base cutter assembly 220 may be configured to float in a manner that allows the vertical positioning of the cutting blades 222 relative to the header frame 202 to be varied or adapted to accommodate changing ground contours/profiles. For instance, the floating base cutter assemblies 220 may allow the cutting blades 222 to generally follow the contour of the ground, such as by allowing each base cutter assembly 220 to shift or move upwardly relative to the frame 202 to accommodate a rise or upward slope in the ground profile and by allowing each base cutter assembly 220 to shift or move downwardly relative to the frame 202 to accommodate a recess or downward slope in the ground profile. As a result, the cutting blades 220 may generally be maintained at a desired position relative to the ground despite variations in the ground contour.

To facilitate the floating arrangement of the base cutter assemblies 220, each base cutter assembly 220 may generally be configured to be coupled to the header frame 202 in any suitable manner that allows for relative movement between the base cutter assembly 220 and the frame 202. In several embodiments, each base cutter assembly 220 is coupled to the frame via a pantographic arrangement. For instance, as shown in FIG. 4, each base cutter assembly 220 is coupled to the frame via a linkage assembly forming a four-bar linkage. The linkage assembly may generally include a pair of linkages or pivot arms 240, 242 (e.g., upper/lower or first/second pivot arms) coupled between each base cutter assembly 220 and the frame 202. Specifically, each pivot arm 240, 242 extends lengthwise between a first end 244 (or frame end) and a second end 246 (or cutter end), with the first end 244 of each arm 240, 242 being pivotably coupled to a portion of the frame (e.g., one of the frame members 204 of the frame 202) at a first pivot point 248 and the second end 246 of each arm 240, 242 being pivotably coupled to a portion of the associated base cutter assembly 220 at a second pivot point 250. As a result, each base cutter assembly 220 may be configured to shift or move both upwardly (e.g., via pivoting of the linkages 240, 242 about the first pivot points 248 in a first pivot direction 252) and downwardly (e.g., via pivoting of the linkages 240, 242 about the second pivot points 250 in an opposed second pivot direction 250) relative to the header frame 202.

It should be appreciated that the relative positioning of the connection points provided between each pivot arm 240, 242 and the frame/assembly may generally be selected to provide desired motion of the base cuter assembly 220 relative to the frame when encountering changes in the ground contour. For instance, in one embodiment, the linkages or pivot arms 240, 242 may be connected between the frame 202 and the associated base cutter assembly 220 in a suitable manner that allows the base cutter assembly 220 to move upwardly relative to the frame 202 as it is forced backwards due to contact with the ground. In such an embodiment, once the bump or raised portion of the ground is cleared, the base cutter assembly 220 may shift forwardly back toward its original position as it moves downwardly relative to the frame 202.

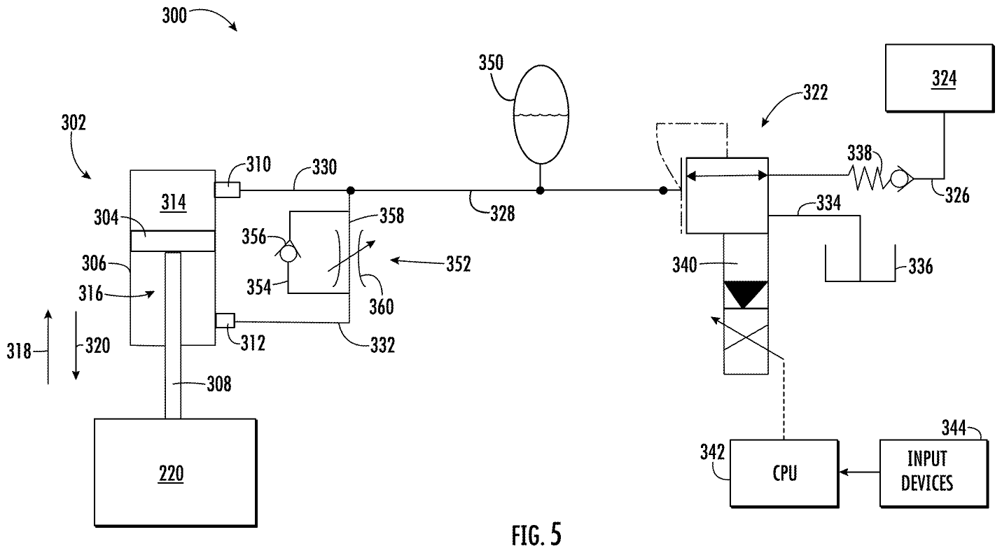

Additionally, in several embodiments, an actuating mechanism or actuator may be provided in operative association with each base cutter assembly 220 to control the movement of the base cutter assembly 220 relative to the frame 202. Specifically, as shown in FIG. 3, a hydraulic actuator 260 is coupled between each base cutter assembly 220 and the frame 202. Each hydraulic actuator 260 may generally be configured to regulate the upward/downward floating motion of its respective base cutter assembly 220 to allow the cutting blades 222 to follow the contour of the ground. For instance, as will be described below with reference to FIG. 5, the hydraulic actuator 260 may be included within (or fluidly coupled to) a suitable hydraulic circuit that allows the associated base cutter assembly 220 to float upwardly relative to the frame 202 when encountering bumps/ridges or other raised portions of the ground and float downwardly relative to the frame 202 when encountering valleys or other recessed portions of the ground. In such an embodiment, the hydraulic actuator 260 may function, for example, as a passive device with the hydraulic circuit.

It should be appreciated that, as opposed to including a pair of base cutter assemblies 220, the header 200 may include any other suitable number of base cutter assemblies 220. For instance, in embodiments in which the header 200 only includes a single pair of crop dividers 206, a single base cutter assembly 220 may be installed on the frame 202 at a position aft of such crop dividers 206. Similarly, in embodiments in which the header 200 includes four or more crop dividers 206, the header 200 may include three or more base cutter assemblies 220 positioned relative to the adjacent pairs of crop dividers 206.

Additionally, it should be appreciated that the header 200 may generally incorporate or include any other suitable harvesting-related components. For instance, as shown in FIGS. 3 and 4, the header 220 may also include a knock-down roller 232 positioned forward of each base cutter assembly 220 (and aft of the crop dividers 206). In such an embodiment, the knock-down rollers 232 may be configured to knock-down or otherwise bend the stalks gathered by the crop dividers 206 towards the ground. Moreover, in addition to the knock-down rollers 232, the header 200 may include or be coupled to one or more topper assemblies, fin rollers, and/or the like. For instance, in one embodiment, the header 200 may include a harvesting configuration similar to the multi-row harvesting arrangement described, for example, in U.S. Pat. No. 9,826,685, filed Oct. 28, 2015 and entitled “Vertical Roller Device to Aid in Feeding Sugar Cane Stalk to Harvester,” the disclosure of which is hereby incorporated by reference herein in its entirety for all purposes. In such an embodiment, the header 200 may, for example, be configured to support vertical rollers (e.g., similar to the vertical rollers disclosed in the above-referenced patent) to assist in guiding sugarcane stalks towards the center of each base cutter assembly 220.

Referring now to FIG. 5, a schematic view of one embodiment of a hydraulic circuit 300 for regulating the movement of a floating base cutter assembly configured for use with a detachable header for an agricultural harvester is illustrated in accordance with aspects of the present subject matter. In general, the hydraulic circuit 300 will be described with reference to the header 200 and one of the base cutter assemblies 220 described above with reference to FIGS. 3 and 4. However, in general, the hydraulic circuit 300 may be configured for use with headers having any other suitable header configuration and/or with base cutter assemblies have any other suitable cutter configuration.

In several embodiments, the hydraulic circuit 300 may generally be configured to allow a substantially constant pressure to be applied against the associated base cutter assembly 220, thereby allowing the base cutter assembly 220 to contact the ground with a constant downforce. For example, as will be described above, the hydraulic circuit 300 may be configured to utilize the concept of a regenerative cylinder to maintain a substantially constant load applied through the base cutter assembly 220 in both movement directions relative to the header frame (e.g., both upward and downward movement).

As shown in FIG. 5, the hydraulic circuit 300 may include a hydraulic actuator 302 configured to be coupled to a floating base cutter assembly 220, which may, for example, correspond to one of the actuators 260 described above with reference to FIGS. 3 and 4. In several embodiments, the hydraulic actuator 302 may comprise a double-acting hydraulic cylinder configured to allow a working fluid (e.g., hydraulic fluid) to be supplied to both sides of the cylinder for extension and retraction thereof. For instance, as shown in FIG. 5, the actuator 302 includes a piston 304 housed within a cylinder 306 and a rod 308 coupled to the piston 304 and extending outwardly from the cylinder 306 to allow the rod 308 to be coupled to a portion of the associated base cutter assembly 220. Additionally, as shown in FIG. 5, the actuator 302 includes first and second fluid ports 310, 312 for supplying fluid to respective first and second fluid chambers 314, 316 defined within the cylinder 306 along opposed sides of the piston 304. As such, the actuator 302 may be configured to accommodate floating movement of the base cutter assembly 220 in both upward and downward movement directions. For instance, in the illustrated embodiment, to allow the base cutter assembly 220 to float upwardly relative to the frame (e.g., in the direction indicated by arrow 318 in FIG. 5), fluid may be supplied to the first or cap-side chamber 314 via the first fluid port 310 as fluid is being simultaneously evacuated or expelled from the second or rod-side chamber 316 via the second fluid port 312. Similarly, to allow the base cutter assembly 220 to float downwardly relative to the frame (e.g., in the direction indicated by arrow 320 in FIG. 5), fluid may be supplied to the second or rod-side chamber 316 via the second fluid port 312 as fluid is being simultaneously evacuated or expelled from the first or cap-side chamber 314 via the first fluid port 310.

Additionally, in several embodiments, the hydraulic circuit 300 may include a pressure regulating valve 322 (PRV) for regulating the pressure of the hydraulic fluid supplied to the actuator 302 (e.g., the cap-side chamber 314 of the actuator 302) from a suitable pressurized fluid source 324, thereby allowing the downforce or load applied to the base cutter assembly 220 to be set or adjusted, as desired. As shown in FIG. 3, the PRV 322 may be fluidly coupled to the pressurized fluid source 324 via a supply line 326 to allow pressurized hydraulic fluid to be supplied thereto. The fluid directed through the PRV 322 may then be supplied to the actuator 302 via a main actuator line 328, with the main actuator line 328 splitting into first and second actuator lines 330, 332 for allowing fluid flow to the first and second fluid ports 310, 312, respectively, of the actuator 302. Additionally, as shown in FIG. 5, the hydraulic circuit 300 also includes a return line 334 for returning fluid back to a fluid source 336 for the circuit 300, such as a fluid tank of the harvester.

It should be appreciated that the pressurized fluid source 324 that supplies pressurized hydraulic fluid through the circuit 300 may generally correspond to any suitable source of pressurized fluid. For instance, in one embodiment, a dedicated pump may be provided for supplying pressurized hydraulic fluid to the circuit 300. Alternatively, the pressurized fluid source 324 may correspond to the primary pressurized fluid source for the harvester (e.g., the primary pump supplying fluid though the harvester's main hydraulic circuit). In such an embodiment, as shown in FIG. 3, a check valve 338 may be provided within the hydraulic circuit 300 downstream of the point at which the circuit 300 ties into or otherwise connects to the main hydraulic circuit (e.g., at a location along the supply line 326), thereby allowing pressurized hydraulic fluid from the main hydraulic circuit to pass through to the hydraulic circuit 300 without allowing any backflow. The check valve 338 may also function to prevent any hydraulic shocks (e.g., due to the base cutter assembly 220 abruptly contacting the ground) from being passed through the hydraulic circuit 300 to the main circuit and interfering with any of the machine's other hydraulic functions.

In one embodiment, the pressure regulating valve (PRV) 322 may correspond to an electronically-controlled valve, such as a solenoid-operated valve including a solenoid 340 configured to actuate the valve 322 between opened and closed positions based on electronic control signals received from an associated electronic controller 342, thereby adjusting the pressure of the hydraulic fluid supplied to the downstream actuator 302 via the actuator line(s) 328, 330, 332. In such an embodiment, the controller 342 may be communicatively coupled to a suitable input device(s) 344 (e.g., a touchscreen, buttons, knobs, operator panel, and/or any other suitable human-machine interface) that allows the operator to provide inputs associated with setting the fluid pressure supplied to the actuator 302 and, thus, the downforce or load applied through the base cutter assembly 220 to the ground. For instance, the input device(s) 344 may, in one embodiment, be positioned within the operator's cab of the harvester to allow the operator to remotely adjust the pressure setting associated with the PRV 322.

It should be appreciated that the controller 342 may generally correspond to one or more processor-based devices, such as one or more computing devices. Thus, the controller 322 may include, for example, one or more processor(s) and associated memory devices configured to perform a variety of computer-implemented functions (e.g., performing one or more methods, steps, algorithms, calculations and/or the like). For instance, the memory may generally be configured to store information accessible to the processor(s), including data that can be retrieved, manipulated, created and/or stored by the processor(s) and instructions that can be executed by the processor(s). For instance, the memory may store computer-readable instructions that, when executed by the processor(s), configure the controller 342 to control the operation of the PRV 322 based on a predetermined setting (e.g., an operator-selected pressure or downforce setting).

It should also be appreciated that the controller 342 may correspond to an existing controller of the harvester/header, such as an existing harvester controller or header controller configured to control the operation of one or more components of the harvester and/or the header. Alternatively, the controller 342 may correspond to a separate processing device. For instance, in one embodiment, the controller 342 may form all or part of a separate plug-in module that may be installed relative to the harvester and/or the header to allow for the desired valve control without requiring additional software to be uploaded onto existing control devices of the harvester and/or the header.

Referring still to FIG. 5, the hydraulic circuit 300 also includes a pressure accumulator 350 in fluid communication with one of the actuator lines 328, 330, 332. For example, as shown in FIG. 4, the pressure accumulator is positioned along the actuator line 328 downstream of the PRV 322 and upstream of the actuator 302. In general, the pressure accumulator 350 may be configured to maintain a substantially constant pressure within the actuator line 328, thereby allowing a substantially constant fluid pressure to applied within the actuator 302 (e.g., within the cap-side chamber 314 of the actuator 302) and, thus, permitting a desired downforce to be applied through the base cutter assembly 220. Specifically, the pressure accumulator 350 may function to prevent or minimize temporary pressure fluctuations within the circuit 300. For instance, the pressure accumulator 350 may be configured to release pressurized hydraulic fluid into the actuator line 328 when the circuit pressure drops below the desired pressure setting/range and/or receive pressurized hydraulic fluid from the actuator line 328 for storage therein when the circuit pressure increases above the desired pressure setting/range.

Moreover, as shown in FIG. 5, the hydraulic circuit 300 further includes a unidirectional flow control valve 352 for regulating the flow of hydraulic fluid supplied to and/or expelled from the actuator's fluid chambers 314, 316 with floating movement of the base cutter assembly 220. In several embodiments, the flow control valve 352 may be configured to unidirectionally restrict fluid flow between the fluid chambers 314, 316 to regulate the speed at which base cutter assembly 220 moves relative to the header frame 202 in one of its movement directions without substantially impacting the movement of the base cutter assembly 220 in the opposed direction. Specifically, in one embodiment, the flow control valve 352 may be configured to allow the associated base cutter assembly 220 to rise or move upwardly relative to the header frame quite rapidly or quickly, thereby avoiding unnecessary shocks or damage to the assembly 220 due to contact with the ground, while controlling the speed of descent of the base cutter assembly 220 to prevent the assembly 220 for moving downwardly too quickly and running into the ground.

For instance, as shown in FIG. 5, the flow control valve 352 is fluidly coupled in-line with the second actuator line 332 and provides two flow paths along such line 332, namely a first flow path 354 incorporating a check valve 356 and a second flow path 358 incorporating flow-restricting orifice 360. In such an embodiment, when the base cutter assembly 220 contacts the ground and moves upwardly (e.g., in direction 318), the piston 304 is pushed upwardly within the cylinder 306, thereby causing fluid to be expelled from the cap-side chamber 314. In such instance, the flow control valve 352 allows such fluid to be passed from the cap-side chamber 314 to the rod-side chamber 316 rapidly via the first flow path 354, as the check valve 356 allows for fluid flow in such direction. However, when the base cutter assembly 220 is floating back downwardly toward the ground in direction 320 (e.g., following the base cutter assembly 220 passing by or clearing the raised portion of the ground), the piston 304 is pulled downwardly within the cylinder 306, thereby causing fluid to be expelled from the rod-side chamber 316. In such instance, since the check valve 326 prevents fluid flow in this opposite direction, the fluid passing from the rod-side chamber 316 to the cap-side chamber 314 is directed through the flow-restricting orifice 360 positioned along the second flow path 358 of the flow control valve 352, thereby controlling the speed at which the fluid passes between the chambers 314, 316 and, thus, damping or slowing the downward movement or descent speed of the base cutter assembly 220. As a result, the base cutter assembly 220 may move downwardly relative to the header frame at a controlled rate.

It should also be appreciated that, as indicated above, the present subject matter is also directed to a header-based harvesting system suitable for use with an agricultural harvester, such as a sugarcane harvester. In several embodiments, the header-based harvesting system may include a header configured to be detachably coupled to an agricultural harvester, with the header including at least one floating base cutter assembly. For instance, in one embodiment, the header-based harvesting system may include one or more of the embodiments of the header 200 described above with reference to FIGS. 3 and 4. Additionally, the header-based harvesting system may also include a hydraulic circuit for regulating the floating movement of the base cutter assembly relative to the header frame via an associated hydraulic actuator. For instance, in one embodiment, the header-based harvesting system may include one or more embodiments of the hydraulic circuit 300 described above with reference to FIG. 5, as well as any other related system components (e.g., the controller 342 and associated input device(s) 344).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A header-based harvesting system for agricultural harvesters, the system comprising:
a header configured to be removably coupled to a front end of a harvester, the header comprising a header frame and a base cutter assembly coupled to the header frame in a floating arrangement;
an actuator coupled between the header frame and the base cutter assembly; and
a hydraulic circuit in fluid communication with the actuator, the hydraulic circuit being configured to allow pressurized hydraulic fluid to be supplied to the actuator for regulating the floating movement of the base cutter assembly relative to the header frame.

2. The system of claim 1, wherein the hydraulic circuit is configured such that the actuator applies a substantially constant downforce to the base cutter assembly during floating movement of the base cutter assembly relative to the header frame.

3. The system of claim 2, wherein the actuator comprises a double-acting hydraulic cylinder configured to regulate floating movement of the base cutter assembly in both a first direction and a second direction opposite the first direction, the hydraulic circuit allowing pressurized hydraulic fluid to be supplied to the actuator in a manner that allows the actuator to apply the substantially constant downforce during floating movement of the base cutter assembly relative to the header frame in both the first and second directions.

4. The system of claim 1, further comprising:
a valve configured to control the supply of pressurized hydraulic fluid to at least one actuator line of the hydraulic circuit extending between the valve and the actuator;
a pressure accumulator fluidly coupled to the at least one actuator line downstream of the valve; and
wherein the pressure accumulator is configured to maintain a substantially constant fluid pressure within the at least one actuator line.

5. The system of claim 4, wherein the valve comprises a pressure regulating valve configured to supply the pressurized hydraulic fluid to the at least one actuator line at the substantially constant pressure.

6. The system of claim 5, wherein:
the pressure regulating valve comprises an electronically-controllable pressure regulating valve;
the system further comprises a controller communicatively coupled to the pressure regulating valve; and
the controller is configured to control an operation of the pressure regulating valve based on a predetermined setting selected for the pressure regulating valve.

7. The system of claim 6, wherein the predetermined setting comprises an operator-selected setting associated with a desired downforce to be applied through the base cutter assembly.

8. The system of claim 1, wherein:
the actuator comprises a double-acting hydraulic cylinder including first and second fluid chambers defined along opposed sides of an associated piston; and
the hydraulic circuit includes at least one actuator line fluidly coupling the first fluid chamber to the second fluid chamber to allow pressurized hydraulic fluid to be transferred between the first and second fluid chambers during floating movement of the base cutter assembly relative to the header frame.

9. The system of claim 8, wherein:
the base cutter assembly is configured to move relative to the header frame in both a first direction and a second direction opposite the first direction;
the system further comprises a flow control valve provided in association with the at least one actuator line; and
the flow control valve is configured to unidirectionally restrict fluid flow between the first and second fluid chambers to regulate a speed at which the base cutter assembly moves relative to the header frame in one of the first direction or the second direction.

10. The system of claim 9, wherein:
the first direction is associated with an upward movement of the base cutter assembly relative to the header frame and the second direction is associated with a downward movement of the base cutter assembly relative to the header frame; and
the flow control valve is configured to restrict fluid flow between the first and second fluid chambers during downward movement of the base cutter assembly relative to the header frame to regulate the speed of descent of the base cutter assembly.

11. The system of claim 1, wherein the base cutter assembly is coupled to header frame of the header via a pantographic arrangement.

12. A header for agricultural harvesters, the header comprising:
a header frame configured to be removably coupled to a front end of an agricultural harvester;
a base cutter assembly coupled to the header frame, the base cutter assembly comprising at least one cutting blade and a drive assembly configured to rotationally drive the at least one cutting blade;
a linkage assembly coupling the base cutter assembly to the header frame such that the base cutter assembly is movable relative to the header frame in both a first direction and a second direction opposite the first direction; and
an actuator coupled between the header frame and the base cutter assembly, the actuator being configured to allow the base cutter assembly to float relative to the header frame in both the first direction and the second direction.

13. The header of claim 12, wherein the base cutter assembly is coupled to the header frame in a pantographic arrangement.

14. The header of claim 13, wherein the linkage assembly comprises first and second pivot arms pivotably coupling the base cutter assembly to the header frame, with the first and second pivot arms forming a four-bar linkage with the base cutter assembly and the header frame.

15. The header of claim 12, further comprising a hydraulic circuit in fluid communication with the actuator, the hydraulic circuit configured to allow pressurized hydraulic fluid to be supplied to the actuator in a manner such that the actuator applies a substantially constant downforce to the base cutter assembly during floating movement of the base cutter assembly relative to the header frame.

16. The header of claim 15, further comprising:
a valve configured to control the supply of pressurized hydraulic fluid to at least one actuator line of the hydraulic circuit extending between the valve and the actuator;
a pressure accumulator fluidly coupled to the at least one actuator line downstream of the valve; and
wherein the pressure accumulator is configured to maintain a substantially constant fluid pressure within the at least one actuator line.

17. The header of claim 16, wherein the valve comprises a pressure regulating valve configured to supply the pressurized hydraulic fluid to the at least one actuator line at the substantially constant pressure.

18. The header of claim 15, wherein:
the actuator comprises a double-acting hydraulic cylinder including first and second fluid chambers defined along opposed sides of an associated piston; and
the hydraulic circuit includes at least one actuator line fluidly coupling the first fluid chamber to the second fluid chamber to allow pressurized hydraulic fluid to be transferred between the first and second fluid chambers during floating movement of the base cutter assembly relative to the header frame.

19. The header of claim 18, wherein:
the system further comprises a flow control valve provided in association with the at least one actuator line; and
the flow control valve is configured to unidirectionally restrict fluid flow between the first and second fluid chambers to regulate a speed at which base cutter assembly moves relative to the header frame in one of the first direction or the second direction.

20. The header of claim 19, wherein:
the first direction is associated with an upward movement of the base cutter assembly relative to the header frame and the second direction is associated with a downward movement of the base cutter assembly relative to the header frame; and
the flow control valve is configured to restrict fluid flow between the first and second chambers during downward movement of the base cutter assembly relative to the header frame to regulate the speed of descent of the base cutter assembly.
